(19) United States
(12) Patent Application Publication
(10) Pub. No.: US 2007/0092148 A1
(43) Pub. Date: Apr. 26, 2007

(54) Method and apparatus for digital image rudundancy removal by selective quantization

(76) Inventors: Oliver Keren Ban, Austin, TX (US); Timothy Alan Dietz, Austin, TX (US); Anthony Cappa Spielberg, Austin, TX (US)

Correspondence Address: DUKE W. YEE;YEE & ASSOCIATES, P.C., P.O. BOX 802333, DALLAS, TX, 75380, US

(21) Appl. No.: 11/255,142

(22) Filed: Oct. 20, 2005

(51) Int. Cl. G06K 9/36; G06K 9/34; G06K 9/00

(52) U.S. Cl. 382/239; 382/173; 382/251

(57) ABSTRACT

A computer implemented method, apparatus, and computer usable code for identifying a set of foreground pixels in an image and a set of background pixels from pixels in the image. The set of foreground pixels is quantized using a first level of quantization to form a set of quantized foreground pixels, and the set of background pixels is quantized using as second level of quantization to form a set of quantized background pixels.

### BACKGROUND OF THE INVENTION

1. Field of the Invention

The present invention relates generally to an improved data processing system and in particular to a method and apparatus for processing image data. Still more particularly, the present invention relates to a computer implemented method, apparatus, and computer usable program code for selectively quantizing image data.

2. Description of the Related Art

A digital image may be processed to reduce the amount of space that the file takes. Current digital imaging compressing systems are normally transformation-based systems. These types of systems are either discreet cosign transform (DCT) based or fractal or transformation based. Typically, the process includes a color space conversion followed by a time domain to frequency domain conversion. Thereafter, frequency domain compression is performed. Finally, variable length coding is performed on the image. Color space conversion may include color quantization. Color quantization is a process in which a set of representative colors are mapped into a single color. This type of processing also may be referred to as color selection or color reduction.

One example compression algorithm is the Joint Photographic Experts Group (JPEG) standard, which is widely used on the web for photographic images. This type of compression system is based on subdividing a frame or picture into eight-by-eight pixel blocks and applying frequency domain and erythematic coding compression algorithm to remove redundancy. These transformation systems use characteristics of similarity between neighboring pixels to selectively quantize to reach the goal of information representation reduction. With these types of frequency domain compression algorithms, all the coding transformations are based on eight-by-eight pixel boundaries. In the intra frame algorithm, motion search algorithms also are pixel based and do not operate outside of an eight-by-eight pixel box.

Compression in a JPEG standard is achieved by dividing the picture into tiny pixel blocks. The typical block size is eight-by-eight pixels. These pixel blocks are halved over and over again until the amount of compression is achieved. As higher levels of compression occur, the picture becomes more lossy.

### SUMMARY OF THE INVENTION

The present invention provides a computer implemented method, apparatus, and computer usable code for processing image data. A set of foreground pixels in an image and a set of background pixels from pixels in the image are identified. The set of foreground pixels is quantized using a first level of quantization to form a set of quantized foreground pixels, and the set of background pixels is quantized using as second level of quantization to form a set of quantized background pixels.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the aspects of the present invention may be implemented;

FIG. 2 is a block diagram of a data processing system in which aspects of the present invention may be implemented;

FIG. 3 is a diagram of a digital image compression system in accordance with an illustrative embodiment of the present invention;

FIG. 4 is a diagram of a picture frame in accordance with an illustrative embodiment of the present invention;

FIG. 5 is a diagram illustrating components used in selectively quantizing image data based on an entire frame or picture in accordance with an illustrative embodiment of the present invention;

FIG. 6 is a diagram illustrating focusing points used to identify foreground and background objects in an optical system in accordance with an illustrative embodiment of the present invention;

FIG. 7 is a flowchart of a process for selectively quantizing pixels in accordance with an illustrative embodiment of the present invention; and

FIG. 8 is a flowchart of a process for identifying foreground objects and background objects in accordance with an illustrative embodiment of the present invention.

### DETAILED DESCRIPTION OF THE PREFERRED EMBODIMENT

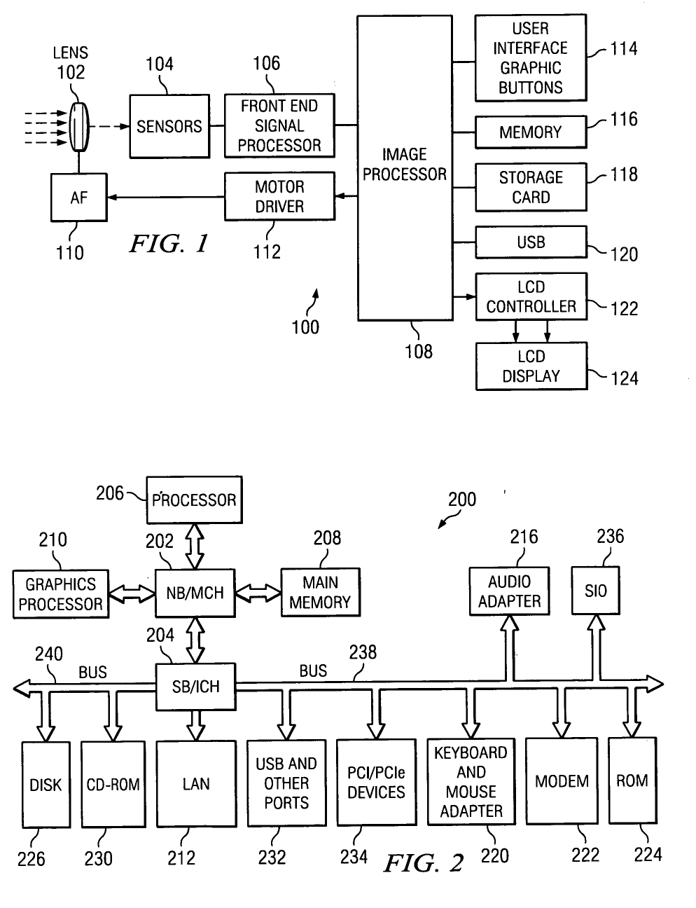

With reference to the figures and in particular with reference to FIG. 1, a block diagram of a data processing system is depicted in which the aspects of the present invention may be implemented. In this example, the data processing system takes the form of digital camera 100. As depicted in FIG. 1, digital camera 100 contains lens 102, sensors 104, front end signal processor 106, image processor 108, auto focus (AF) 110, motor driver 112, user interface graphics buttons 114, memory 116, storage card 118, USB interface 120, LCD controller 122, and LCD display 124.

Light for an image is received through lens 102 to collect and generate a signal containing the image. Sensors 104 consists of an array of pixels that collect photons to generate charges. Sensors 104 may take various forms. For example, sensors 104 may be implemented using charge-coupled device (CCD) sensors or complimentary metal-oxide-semiconductor (CMOS) sensors.

Front end signal processor 106 processes the signals from sensors 104. For example, front end signal processor 106 filters, amplifies, and then digitizes signals from sensors 104. Image processor 108 is used to provide the processing power to handle various imaging, audio, and video processes. Further, image processor 108 controls the timing relationship of vertical and horizontal reference signals.

Auto focus 110 provides two functions in this example. First, auto focus 110 is employed to keep lens 102 focused on a subject. Motor driver 112 is used to operate auto focus 110.

User interface graphic buttons 114 are employed to provide an interface to the user to perform various functions with digital camera 100. These functions may include, for example, taking a picture, deleting a previously taken picture, viewing stored images, changing the focus of digital camera 100, and turning the power on and off.

Memory 116 stores code executed by image processor 108. Further, memory 116 also stores image data. Storage card 118 is used for the storage of images as well as software and other data. When an image in memory 116 has been processed and is ready for storage, the image is stored in storage card 118. USB 120 provides an interface to send and receive data to a remote device, such as a computer or a printer. LCD controller 122 controls LCD display 124. This display is used to present information to the user. For example, LCD display 124 may display an image received by sensors 104.

In FIG. 2, a block diagram of a data processing system is shown in which aspects of the present invention may be implemented. Data processing system 200 is an example of a computer in which code or instructions implementing the processes of the present invention may be located. In these examples, data processing system 200 may perform the processing of images. Further, data processing system 200 also may be connected to digital camera 100 in FIG. 1 to process data collected by this device.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention recognize that currently available compression algorithms for compressing images are limited because none of these algorithms take into account different aspects of the image, such as the entire frame or picture. Instead, the presently available compression algorithms are based on pixel boxes, which do not take into account whether objects in different locations of the frame or picture require different amounts of compression.

In particular, the aspects of the present invention provide for selectively quantizing different portions of an image at different levels. Quantizing is a well known step in the process of converting an analog signal into a digital analog signal. This step measures a sample to determine a representative numerical value that is then encoded. The different aspects of the present invention allows for some portion or portions of the image to be quantized at a lower level. In these examples, quantization is part of a process to digitize an image. For example, an image may be divided up into a number of different pixels. Then, an integer pixel value is associated with the average reflectance value in the original image. In other words, quantization is the process of sampling an analog signal value and converting the sample into a predefined numerical or digital value.

The aspects of the present invention allow for different levels of quantization for different portions of an image. As a result, a courser or lower level of quantization results in less data as apposed to higher or finer level of quantization. When a lower level of quantization occurs, the result is the ability to increase the amount of compression as opposed to an image that is quantized all at the same level.

For example, if a courser level of quantization results in 3-6 bits for a pixel group as opposed to 10 to 16 bits with a finer local quantization. With less data, compression is realized in a higher rate because of the reduced amount of data that is generated even before other conversion or compression processes are performed. In these examples, the processes of the present invention may be implemented prior to other compression processes, such as color space conversion.

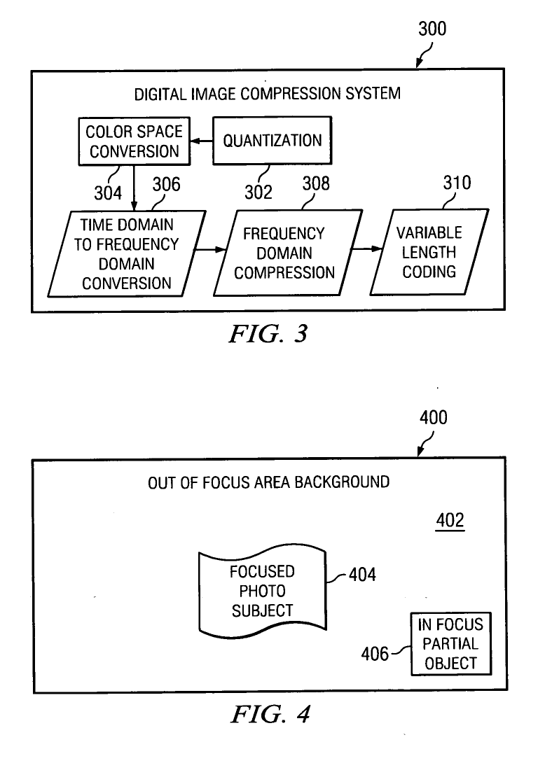

Turning now to FIG. 3, a diagram of a digital image compression system is depicted in accordance with an illustrative embodiment of the present invention. In this example, digital image compression system begins with quantization 302. Quantization 302 performs a quantization process to generate data from analog values in a signal. For example, quantization 302 may generate a value for a signal generate for a pixel in a sensor. The amount of data generated depends on the level of quantization performed by quantization 302.

The aspects of the present invention provide for selective quantization by quantization 302 such that different portions of an image or frame are quantized at different levels. As a result, when a portion of the image is considered as not being as important or emphasized, that portion of the image may be quantized at a lower level. Thus, less data is generated with respect to other portions of the image that are quantized at a higher level. In this manner, levels of quantization less than that used by a particular standard may be employed when a portion of an image is considered to be less important or require less emphasis.

Color space conversion 304 is used to convert the image from one color space to another color space. The color space is a system of ordering colors that respect relationships of similarity among the colors. Time domain to frequency domain conversion 306 converts data from a time based domain to a frequency based domain. Time domain to frequency domain conversion 306 may implement a discrete transform to perform the conversion of the graphics data. This frequency domain data is processed by frequency domain compression 308, which is used to compress the data.

Variable length coding 310 allocates codes of different lengths to different input data according to the probability of accordance of input data. This coding is such that statistically, more frequent input codes are allocated shorter codes then less frequent codes. Less frequent input codes are allocated longer codes. This allocation of codes by variable length coding 310 may be performed either statistically or adaptively. the particular component provides for additional compression of the graphics data.

Digital image compression system 300 may implement various standards. An example of one standard is the joint photographic experts group (JPEG) compression scheme. The aspects of the present invention may provide improvements to these and other types of compression schemes through variable quantization based on spatial locations of pixels in an image or frame. Such an approach is in contrast to currently used standards, which subdivide the entire frame into uniform blocks or groups of pixels and perform frequency domain compression within these groupings. Additionally, other compression schemes are pixel based and do not look outside of a particular grouping of pixels, such as an 8×8 box.

In contrast, the aspects of the present invention separate background pixels from foreground pixels and selectively quantizes these pixels in an order of fine quantization for focused. foreground pixel groups and a course quantization for out of focus background pixel groups. A finer quantization is performed with foreground pixels because these are the objects for which the user focuses on when looking at a picture. Out-of focus pixels for objects in the background are the ones that the user does not pay as much attention to and would require less quantization and less data recorded for these objects in the background.

Although two different levels of quantization are illustrated in these examples, additional levels of quantization may be employed depending on the particular implementation. For example, three levels of quantization may be employed. With three levels, the lowest level may be, for example, for a background, such as the sky. A higher level of quantization may be employed for objects that are on the periphery of the frame but in focus. A highest level of quantization may be performed for objects that are in-focus and more centrally located in the frame or picture.

Turning now to FIG. 4, a diagram of a picture frame is depicted in accordance with an illustrative embodiment of the present invention. In picture 400, background 402 and focus photo subject 404 are present. Most pictures have a large portion of background, such as that shown in picture 400 that is relatively out of focus. A few blocks of images of relatively small size foreground objects are in the focus range, such as focused photo subject 404 and in focus partial object 406. Statistically, the aspects of the present invention recognize that the entropy of the picture from the interframe point of view is not evenly distributed.

The aspects of the present invention recognize that the current compression schemes only address those images redundancy removal in the frequency domain and the arithmetic coding domain. The aspects of the present invention also recognize that none of these compression schemes recognize or address the space domain as in the aspects of the present invention.

In this manner, the aspects of the present invention provide a computer implemented method, apparatus, and computer usable program code for compressing digital images using the space domain in addition to the other types of compression processes. In the illustrative examples, background pixels and foreground pixels are separated from each other. These different groups of pixels are then selectively quantized with a finer quantization being used for foreground pixel groups and a courser quantization being performed for background pixel groups. Although these examples only show quantization based on two groups of pixels, three or more groups of pixels may be selected for different types of quantization depending on the particular implementation.

By comparing the result from multiple focusing points, the in-focus foreground pixel groups may be separated and quantized on a fine scale, such as ten to sixteen bits. The leftover pixels, which are considered out of focus in the background, are quantized only in a courser scale, such as 3 to 6 bits, rather than using standard quantization values. As a result, the compression using the different aspects of the present invention are at a higher ratio rate even before color space conversion, such as that used in JPEG standards, are employed.

The aspects of the present invention provide quantized only the in-focused or foreground objects on a fine scale with background objects being quantized on a 2×to 3×difference scale depending on the nature of the pictures. In these examples, different groups of pixels are stored in different frame buffers.

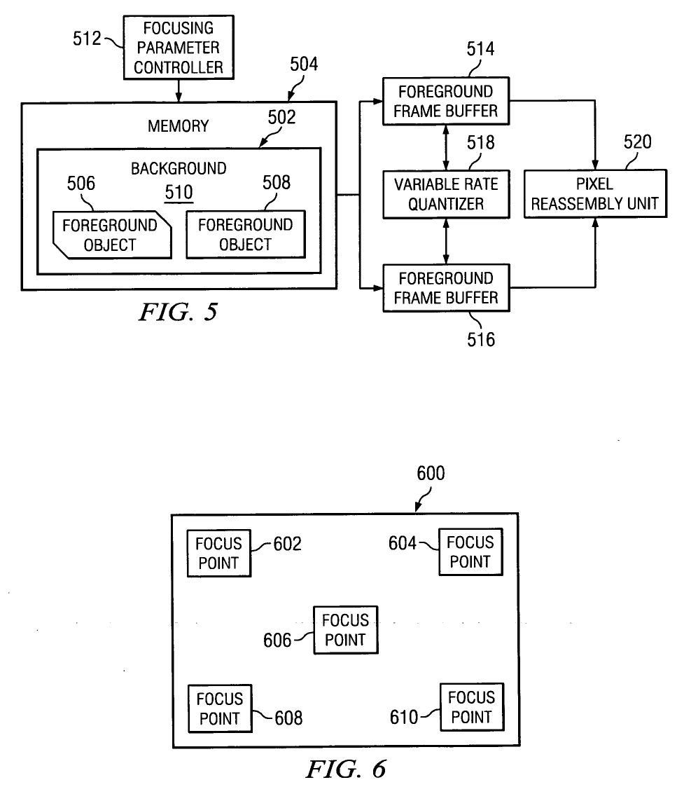

Turning now to FIG. 5, a diagram illustrating components used in selectively quantizing image data based on an entire frame or picture is depicted in accordance with an illustrative embodiment of the present invention. Quantization system 500 may be located in a data processing system, such as digital camera 100 in FIG. 1 or in data processing system 200 in FIG. 2.

In this example, quantization system 500 processes picture 502, which is stored in memory 504. Picture 502 is a picture or a frame similar to picture 400 in FIG. 4. Memory 504 is similar to a memory, such as memory 116 found in digital camera 100 in FIG. 1 or main memory 208 in FIG. 2.

In this example, picture 502 contains foreground object 506 and 508 and background 510. In an illustrative embodiment, focusing parameter controller 512 is employed to identify foreground pixels and background pixels. In the depicted examples, foreground pixels are those pixels that are considered to be in focus, while background pixels are those pixels that are considered to be out of focus. Focusing parameter controller 512 also associates coordinate data with the pixels such that the pixels may be reassembled at a later time to reform the picture after quantization has been performed. The coordinate data may be associated in a number of different ways. For example, the coordinate data may be associated with each pixel or with each object.

Whether a pixel is in-focus may be determined a number of different ways. For example, in data processing system, such as data processing system 200, currently available pattern matching algorithms may be employed to identify objects that are in-focus as well as objects that are out of focus. In this manner, the pixels for these objects may be grouped to identify foreground pixels and background pixels. Alternatively, an optical system may be employed if the process is implemented in a digital camera, such as digital camera 100 in FIG. 1. Focusing points may be used to identify background objects and foreground objects. As a result, the pixels for these objects may be identified and grouped for selective quantization.

Once the pixels are identified by focusing parameter controller 512, pixels for foreground object 506 and foreground objects 508 are sent to foreground frame buffer 514. The remaining background objects in background 510 are sent to background frame buffer 516.

Variable rate quantizer 518 quantizes the data for these different pixels with a different amount of granularity. For example, foreground frame buffer 514 is quantized with a finer granularity resulting in more data being generated for the pixels for these objects. The pixels located in background frame buffer 516 are quantized with a courser granularity resulting in less data being generated for each of these pixels. For example, pixels in foreground frame buffer 514 may be quantized to generate 10 to 16 bits of data for each pixel. The pixels located in background frame buffer 516 may be quantized to generate data on a scale of 3 to 6 bits per pixel rather than using a standard quantization value. In these examples, a standard quantization is a uniform quantization that results in 8 bits per pixel or 24 bits per pixel throughout the entire frame or picture. With the selective quantization in the illustrative examples, 24 bits per pixel are generated for foreground pixels and 8 bits per pixels are generated for background pixels.

Pixels that have been quantized by variable rate quantizer 518 the pixels in foreground frame buffer 514 and background frame buffer 416 are combined using pixel reassembly unit 520. Pixel reassembly unlit 520 combines the pixels and places them back into the original locations within a picture based on the coordinate information associated with those pixels.

Once pixel reassembly unit 520 has reassembled picture 502 from the pixels in foreground frame buffer 514 and background frame buffer 516, color conversion may be performed as described above with respect to FIG. 3.

Focusing parameter controller 512 and variable rate quantizer 518 may be implemented in software, hardware, or a combination of the two. When implemented in hardware, these components may be implemented as application specific integrated circuits (ASICs). These particular features may be implemented within a graphics processor in a computer system or an image processor in a digital camera in these illustrative examples. Foreground frame buffer 514 and background frame buffer 516 may be allocated from frame buffer memory photographic processor or image processes.

Turning now to FIG. 6, a diagram illustrating focusing points used to identify foreground and background objects in an optical system is depicted in accordance with an illustrative embodiment of the present invention. In this example, picture 600 contains focusing points 602, 604, 606, 608, and 610. These focusing points are typically generated by a digital camera in identifying which objects should be in focus when a picture is taken. The number of focusing points may vary depending on the particular focusing scheme used by digital camera. As a result, a set of objects within a focusing point are in focus while other objects may be out of focus. This set of objects may include one or more objects in these examples. These focusing points are used to identify objects the set of objects in the foreground. With the identification of foreground objects, the set of foreground objects may be separated from background objects. In this manner, the pixels for these objects may be sent to be appropriate frame buffer for selective quantization using the mechanism described above with respect to quantization system 500 in FIG. 5.

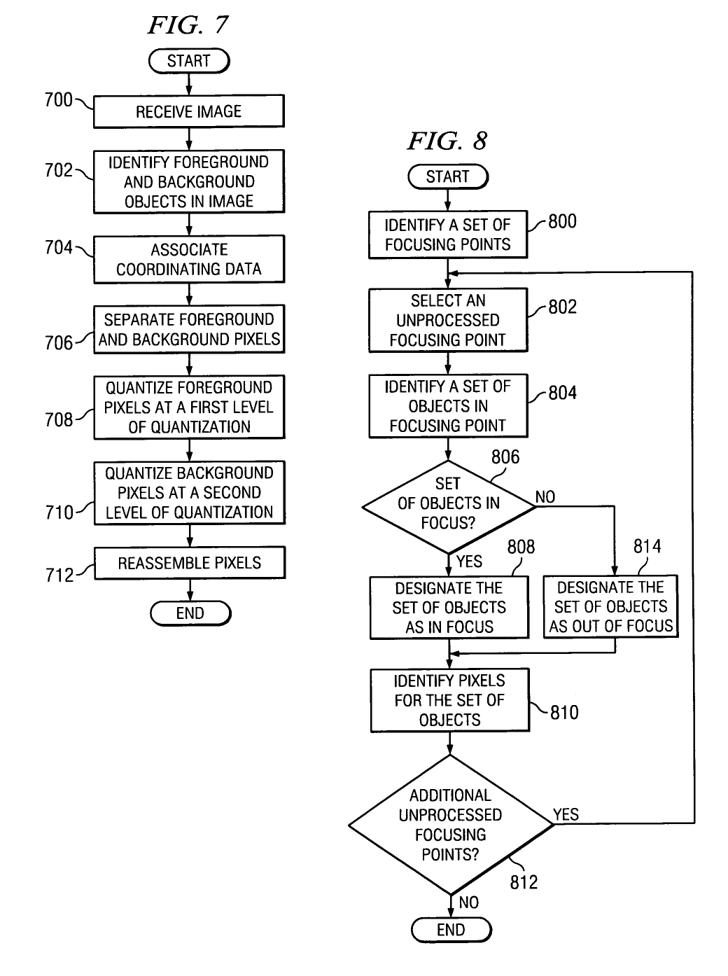

Turning next to FIG. 7, a flowchart of a process for selectively quantizing pixels is depicted in accordance with an illustrative embodiment of the present invention. The process illustrated in FIG. 7 may be implemented in quantizing system 500 in FIG. 5. In particular, these steps may be implemented in focusing parameter controller 512, variable rate quantizer 518, and pixel reassembly unit 520 in FIG. 5. In these examples, steps 700-706 are performed by a focusing parameter controller while steps 708 and 710 are performed by a variable rate quantizer. Step 712 is performed by pixel reassembly unit 520 in FIG. 5.

The process begins by receiving an image (step 700). This image is stored in a memory, such as memory 504 in FIG. 5. Foreground objects and background objects in the image are identified (step 702). The process associates coordinate data with the objects identified for the foreground and the objects identified in the background (step 704). The foreground and background pixels are separated from each other (step 706). In these examples, the foreground pixels and background pixels are stored in separate frame buffer for processing. The foreground pixels are quantized to the first level of quantization (step 708), and the background pixels are quantized using a second level of quantization (step 710).

In these examples, the foreground pixels are quantized at a first level that generates more data for each pixels then pixels quantized at a second level for the background pixels. Further, depending on the particular implementation, additional levels of quantization may be performed. For example, partial objects at the corners of a picture frame may be quantized at a level of quantization that is less then that of the main subject but greater than that of the background. Thereafter, the pixels are reassembled (step 712).

With reference now to FIG. 8, a flowchart of a process for identifying foreground objects and background objects is depicted in accordance with an illustrative embodiment of the present invention. The process illustrated in FIG. 8 is a more detailed description of step 702 in FIG. 7. In particular, this process illustrates an optical mechanism for identifying foreground and background objects that may be implemented in a digital camera, such as digital camera 100 in FIG. 1.

The process begins by identifying a set of focusing points (step 800). Thereafter, the process selects an unprocessed focusing point from the set of focusing points (step 802). A set of objects is identified in the focusing point (step 804). A set of objects may be one or more objects. An object may be, for example, a person, a table, a cloud, or just blue sky. A determination is made as to whether the set of objects is in focus (step 806). If the set of objects is in-focus, the process designates the set of objects as being in focus (step 808). The pixels for the set of objects are identified (step 810). In this case, these pixels are foreground pixels since the set of objects is in-focus.

Thereafter, a determination is made as to whether additional unprocessed focusing points are present, if additional unprocessed focusing points are present, the process returns to step 802 to select another focusing point for processing. Otherwise, the process terminates.

With reference again to step 806, if the set of objects is not in focus, the set of objects is designated as being out of focus (step 814). The pixels for this set of objects are identified. In this particular set of objects, these pixels are background pixels because the set of objects is out of focus. Thereafter, the process proceeds to step 812 as described above.

With respect to whether objects are in focus, auto focusing is a feature currently available in various cameras. Typically, the image processor controls a motor for the auto focus system to move the lens in and out until the sharpest image of the object is present. In an act of auto focus system, a signal is emitted and bounces off a particular point on an object in a picture to identify the distance to determine what movement of the lens is needed to focus the object. Many digital cameras use an infrared focusing system that selects one or more points for focusing.

In a passive auto focus system, the distance to the subject is determined by analyzing the image itself rather than sending a signal that bounces off the image. The processor looks at a strip of pixels and determines the difference in the intensity among adjacent pixels. If a scene is out of focus, adjacent pixels have very similar intensities. The lens is then adjusted. When a particular portion of an image is in-focus, the intensity between adjacent pixels are sharper. A similar process is performed using pattern recognition to identify objects and whether the objects are in or out of focus.

In this manner, the aspects of the present invention provide a computer implemented method, apparatus, and computer usable program product for improving compression of digital images. The aspects of the present invention selectively quantizes the data for pixels prior to color space conversion during a compression process. In particular, different groups of pixels are quantized at different levels. As a result, some groupings of pixels have more data than others. In these examples, the groupings of pixels are based on objects. Pixels for objects in the foreground are quantized at a finer scale to generate more data than pixels identified for objects in the background. The scale may be, for example, a two to three times difference in the amount of data that is generated between foreground objects and background objects. By separating these pixels, the amount of information that needs to be compressed and transmitted is reduced.

In these examples, the focus controller is designated in a manner similar to a focus coordination unit in a camera. With a buffer to remember every pixels origination in a frame. The shape of an object may be any shape, such as a rectangular shape, or any other shape, even a variable shape as long as the shape position parameters may be coded. As a result, the aspects of the present invention may be viewed as an addition to a standard compression scheme to further reduce redundancy. For example, the aspects of the present invention may be used to quantize data before other processing in a JPEG compression system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing image data, the computer implemented method comprising:
identifying a set of foreground pixels in an image and a set of background pixels from pixels in the image;
quantizing the set of foreground pixels using a first level of quantization to form a set of quantized foreground pixels; and
quantizing the set of background pixels using as second level of quantization to form a set of quantized background pixels.

2. The computer implemented method of claim 1 further comprising:
reassembling the image from the set of quantized foreground pixels and the set of quantized background pixels based on an original location of the pixels to form a reassembled image; and
performing color space conversion on the reassembled image.

3. The computer implemented method of claim 1, wherein the identifying step comprises:
comparing focusing points from a plurality of focusing points to identify in-focus points and out of focus points in the image;
identifying first pixels for a first object in from the image located within an focus point as being in the set of foreground pixels; and
identifying second pixels for a second object in from the image located within an out of focus point as being in the set of background pixels.

4. The computer implemented method of claim 1, wherein the first level of quantization is a finer level of quantization as compared to the second level of quantization.

5. The computer implemented method of claim 1 further comprising:
identifying another set of pixels from the pixels in the image; and
quantizing the another set of pixels using a third level of quantization.

6. The computer implemented method of claim 1 further comprising:
placing the first pixels in a first frame buffer; and
placing the second pixels in a second frame buffer.

7. The computer implemented method of claim 1, wherein the computer implemented method is performed within a graphics adapter in a data processing system.

8. An image processing apparatus comprising:
a memory containing an image;
a first frame buffer;
a second frame buffer; and
a variable rate quantizer, wherein the variable rate quantizer quantizes a first set of pixels in the first frame buffer for the image in the memory in a first level of quantization and quantizes the second set of pixels in the second frame buffer for the image in memory at a second level of quantization.

9. The image processing apparatus of claim 8 further comprising:
a pixel assembly unit connected to the first frame buffer and the second frame buffer, wherein the pixel reassembly unit reassembles the picture using the first set of pixels and the second set of pixels after quantization has been performed by the variable rate quantizer.

10. The image processing apparatus of claim 8 further comprising:
a focusing parameter controller, wherein the focusing parameter controller identifies the first set of pixels and the second set of pixels from pixels forming the image.

11. A computer program product comprising:
a computer usable medium having computer usable program code for processing image data, said computer program product including:
computer usable program code for identifying a set of foreground pixels in an image and a set of background pixels from pixels in the image;
computer usable program code for quantizing the set of foreground pixels using a first level of quantization to form a set of quantized foreground pixels; and
computer usable program code for quantizing the set of background pixels using as second level of quantization to form a set of quantized background pixels.

12. The computer program product of claim 11 further comprising:
computer usable program code for reassembling the image from the set of quantized foreground pixels and the set of quantized background pixels based on an original location of the pixels to form a reassembled image; and
computer usable program code for performing color space conversion on the reassembled image.

13. The computer program product of claim 11, wherein the computer usable program code for identifying a set of foreground pixels in an image and a set of background pixels from pixels in the image comprises:
computer usable program code for comparing focusing points from a plurality of focusing points to identify in-focus points and out of focus points in the image;
computer usable program code for identifying first pixels for a first object in from the image located within an focus point as being in the set of foreground pixels; and
computer usable program code for identifying second pixels for a second object in from the image located within an out of focus point as being in the set of background pixels.

14. The computer program product of claim 11, wherein the first level of quantization is a finer level of quantization as compared to the second level of quantization.

15. The computer program product of claim 11 further comprising:
computer usable program code for identifying another set of pixels from the pixels in the image; and
computer usable program code for quantizing the another set of pixels using a third level of quantization.

16. The computer program product of claim 11 further comprising:
computer usable program code for placing the first pixels in a first frame buffer; and
computer usable program code for placing the second pixels in a second frame buffer.
